(19) United States
(12) Patent Application Publication
(10) Pub. No.: US 2022/0095877 A1
(43) Pub. Date: Mar. 31, 2022

(54) CLEANING SHEET AND METHOD FOR PRODUCING CLEANING SHEET

(71) Applicant: DAIO PAPER CORPORATION, Shikokuchuo-shi, Ehime (JP)

(72) Inventor: Yuhei YAMASAKI, Shikokuchuo-shi (JP)

(73) Assignee: DAIO PAPER CORPORATION, Shikokuchuo-shi, Ehime (JP)

(21) Appl. No.: 17/423,302

(22) PCT Filed: Jan. 9, 2020
(86) PCT No.: PCT/JP2020/000371

§ 371 Date: Jul. 15, 2021

(30) Foreign Application Priority Data
Jan. 21, 2019 (JP) 2019-007875

(51) Int. Cl. A47L 13/17; D21H 11/18; D21H 15/02; D21H 19/34; C11D 17/06; C11D 7/26

(52) U.S. Cl. CPC A47L 13/17; D21H 11/18; C11D 7/263; D21H 19/34; C11D 17/06; D21H 15/02

(57) ABSTRACT

A cleaning sheet includes a base paper sheet that is impregnated with an aqueous agent. The aqueous agent includes butyldiglycol that is a glycol ether.

### TECHNICAL FIELD

The present invention relates to a cleaning sheet and a method for producing the cleaning sheet.

### BACKGROUND ART

In recent years, disposable cleaning sheets made of paper have spread to be used for cleaning toilets. The cleaning sheets are generally provided in a wet state of being impregnated with a detergent and can be processed by being flushed down the toilets after use (for example, see patent document 1).

Such a wet-type cleaning sheet contains an agent of propylene glycol monomethyl ether (PGME) that is included in glycol ethers in order to improve the surface strength of the sheet. Though this PGME is an agent having a peculiar odor, the odor is masked by fragrance included in the detergent.

### CITATION LIST

### Patent Literature

[Patent Document 1] JP 2018-172802 A

### SUMMARY OF INVENTION

### Technical Problem

An increasing number of users have recently preferred to unscented or slightly scented products. Thus, the present inventor has intensively considered, and developed an unscented type cleaning sheet that has a good surface strength and can be suitably used.

An object of the present invention is to provide a cleaning sheet that can suppress an odor while having a surface strength and can be suitably used, and a method for producing the cleaning sheet.

### Solution to Problem

In order to achieve the object, according to the invention recited in claim 1, there is provided a cleaning sheet including a base paper sheet that is impregnated with an aqueous agent, wherein the aqueous agent includes butyldiglycol that is a glycol ether.

By replacing at least part of propylene glycol monomethyl ether included in the aqueous agent with butyldiglycol, it is possible to suppress the odor of the aqueous agent for the amount of replacement.

The cleaning sheet impregnated with such an aqueous agent has a surface strength that can be suitably used, and can be used without caring the odor.

According to the invention recited in claim 2, there is provided the cleaning sheet according to claim 1, wherein the aqueous agent includes a glycol ether by 10 to 19%, and includes butyldiglycol by 35 to 56% in the glycol ether.

By including the butyldiglycol of such blending in the aqueous agent, the cleaning sheet can be suitably used as a cleaning sheet that has a good surface strength.

According to the invention recited in claim 3, there is provided the cleaning sheet according to claim 1, wherein a glycol ether included in the aqueous agent includes butyldiglycol by 50% or more.

By including the butyldiglycol of such blending in the aqueous agent, the cleaning sheet can be suitably used as an unscented type cleaning sheet.

According to the invention recited in claim 4, there is provided the cleaning sheet according to any one of claims 1 to 3, wherein

the base paper sheet contains a water-soluble binder, and

the aqueous agent includes a cross-linking agent that cross-links with the water-soluble binder.

According to the invention recited in claim 5, there is provided a method for producing a cleaning sheet including:

CNF adding that is adding cellulose nanofibers to a base paper sheet; and

aqueous agent adding that is adding, to the base paper sheet, an aqueous agent that includes propylene glycol monomethyl ether and butyldiglycol.

According to the invention recited in claim 5, there is provided the method for producing the cleaning sheet according to claim 5, further comprising:

binder adding that is adding, to the base paper sheet, a solution that contains a water-soluble binder; and

drying that is drying a sheet to which the water-soluble binder and the cellulose nanofibers have been added, wherein

in the aqueous agent adding, the aqueous agent is added to the sheet that has been dried in the drying.

### Advantageous Effects of Invention

According to the present invention, a cleaning sheet that has the odor suppressed while having a surface strength and can be suitably used is obtained.

### BRIEF DESCRIPTION OF DRAWINGS

FIG. 1 is a plan view showing an example of a toilet cleaning sheet (cleaning sheet) in the present embodiment.

FIG. 2A is a view showing fiber orientation of conventional paper.

FIG. 2B is a view showing fiber orientation of the present invention.

FIG. 3A is an enlarged view and a sectional view of emboss portions of the toilet cleaning sheet.

FIG. 3B is an enlarged view and a sectional view of emboss portions of the toilet cleaning sheet.

FIG. 3C is an enlarged view and a sectional view of emboss portions of the toilet cleaning sheet.

FIG. 4A is an explanatory view showing an example of a contact area of embosses.

FIG. 4B is an explanatory view showing an example of a contact area of embosses.

FIG. 5 is a flowchart showing a method for producing the toilet cleaning sheet according to the present embodiment.

FIG. 6 is a schematic view of equipment (solution addition equipment) for producing the toilet cleaning sheet according to the present embodiment.

FIG. 7 is a schematic view of equipment (processing equipment) for producing the toilet cleaning sheet in the present embodiment.

FIG. 8 is a schematic view showing an example of a papermaking machine.

### DESCRIPTION OF EMBODIMENTS

Hereinafter, an embodiment of the cleaning sheet of the present invention are described in detail with reference to the drawings. Though various technically preferable limitations for carrying out the present invention are provided to the following embodiment, the scope of the present invention is not limited to the following embodiment or illustrated examples.

The cleaning sheet will be described by taking, as an example, a toilet cleaning sheet as a water-disintegrable sheet, but the cleaning sheet also includes other cleaning sheets and the like. The conveyance direction of the paper at the time of producing the toilet cleaning sheet is referred to as the Y direction (longitudinal direction), and the direction orthogonal to the conveyance direction is described as the X direction (lateral direction).

[Description of Toilet Cleaning Sheet (Cleaning Sheet)]

The toilet cleaning sheet 100 is a wet type cleaning sheet for toilets that is formed by applying ply process (laminating) to multiple (for example, two) base paper sheets and is impregnated with a predetermined aqueous agent. The base paper sheet may be formed of a single base paper sheet to which a ply process has not been applied.

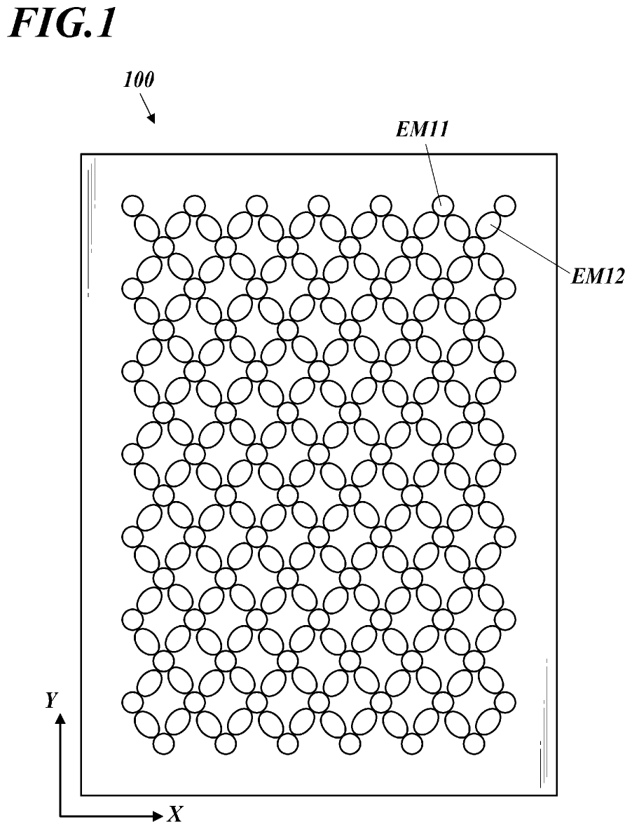

Although the surface of the toilet cleaning sheet 100 may be the base paper sheet as it is, embossing is preferably applied. For example, as shown in FIG. 1, two kinds of embosses EM11 and EM12 are provided.

The toilet cleaning sheet 100 in the present embodiment is a cleaning sheet obtained by impregnating the sheet of the two laminated base paper sheets with the aqueous agent. The weight per unit area of one sheet of the base paper sheets is preferably 30 to 150 gsm. The weight per unit area is based on JIS P 8124.

[Base Paper Sheet]

The base paper sheet of the toilet cleaning sheet 100 is configured with a water-disintegrable fiber aggregate so that it can be discarded in the toilet water pool as it is after cleaning the toilet.

The fiber aggregate is not particularly limited as long as it has water-disintegrability, but a single layer or multiple layers of paper or nonwoven fabric can be suitably used. The fiber raw material may be a natural fiber or a synthetic fiber, and they may be mixed. Suitable fiber raw materials include cellulosic fibers such as wood pulp, non-wood pulp, rayon, and cotton, biodegradable fibers made of polylactic acid, and the like. In addition, with these fibers as a main component, polyethylene fibers, polypropylene fibers, polyvinyl alcohol fibers, polyester fibers, polyacrylonitrile fibers, synthetic pulp, glass wool, and the like may be used in combination.

In particular, a fiber aggregate containing at least pulp is preferable, and suitable pulp to be used as a raw material is leaf bleached kraft pulp (LBKP) and needle bleached kraft pulp (NBKP) blended at an appropriate ratio.

More preferably, a blending ratio of the leaf bleached kraft pulp exceeds 50% by weight, in other words, the blending ratio of the needle bleached kraft pulp to the leaf bleached kraft pulp is less than 1/1. By increasing the blending ratio of the leaf bleached kraft pulp to the needle bleached kraft pulp, gaps between fibers is reduced and moisture transpiration is suppressed. Therefore, it is possible to improve difficulty of drying.

Further, it may be configured of a sheet made of crushed pulp or a sheet of crushed pulp covered or sandwiched with water-disintegrable paper.

[Water-Soluble Binder]

A water-soluble binder for enhancing paper strength is added to the base paper sheet of the toilet cleaning sheet 100. Examples of the water-soluble binder include a binder component such as carboxymethyl cellulose polyvinyl alcohol, starch or a derivative thereof, hydroxypropyl cellulose, sodium alginate, trant gum, guar gum, xanthan gum, gum arabic, carrageenan, galactomannan, gelatin, casein, albumin, purplan, polyethylene oxide, Viscose, polyvinyl ethyl ether, sodium polyacrylate, sodium polymethacrylate, polyacrylamide, hydroxylated derivatives of polyacrylic acid, polyvinyl pyrrolidone/vinyl pyrrolidone vinyl acetate copolymer, and the like.

In particular, from the viewpoint of good water-disintegrability and the possibility of developing wet strength by cross-linking reaction, a water-soluble binder having a carboxyl group is preferably used.

The water-soluble binder having a carboxyl group is an anionic water-soluble binder which readily generates carboxylate in water. Examples thereof include polysaccharide derivatives, synthetic polymers, and natural products.

Examples of the polysaccharide derivative include a salt of carboxymethyl cellulose, carboxyethyl cellulose or a salt thereof, and carboxymethylated starch or a salt thereof, and an alkali metal salt of carboxymethyl cellulose (CMC) is particularly preferable.

It is desirable that CMC has an etherification degree of 0.6 to 2.0, particularly 0.9 to 1.8, more preferably 1.0 to 1.5. The water-disintegrability and the development of wet paper strength are extremely good.

It is preferable to use water-swellable CMC. This exerts a function of linking the fibers constituting the sheet while remaining unswollen by forming cross-links with a specific metal ion as the cross-linking agent in the aqueous agent, so that strength as a durable wiping sheet in cleaning/wiping is exhibited.

In the case of the toilet cleaning sheet 100 of the present embodiment, CMC is added as the water-soluble binder.

Examples of the synthetic polymers include a salt of a polymer or a copolymer of an unsaturated carboxylic acid, a salt of a copolymer of an unsaturated carboxylic acid and a monomer copolymerizable with the unsaturated carboxylic acid, and the like. Examples of the unsaturated carboxylic acid include acrylic acid, methacrylic acid, itaconic acid, crotonic acid, maleic anhydride, maleic acid, fumaric acid, and the like. Examples of the monomer copolymerizable with them include esters of these unsaturated carboxylic acids, vinyl acetate, ethylene, acrylamide, vinyl ether, and the like. A particularly preferred synthetic polymer is one using acrylic acid or methacrylic acid as the unsaturated carboxylic acid, and specifically include salts of polyacrylic acid, polymethacrylic acid, or acrylic acid methacrylic acid copolymer, and salts of a copolymer of acrylic acid or methacrylic acid, an alkyl acrylate or alkyl methacrylate.

Examples of natural products include sodium alginate, xanthan gum, gellan gum, tarraganth gum, pectin, and the like.

[Cellulose Nanofibers]

In addition, cellulose nanofibers (hereinafter referred to as CNF) can be added to the toilet cleaning sheet 100.

That is, CNF can be added to the water-soluble binder (CMC in the case of the present embodiment).

CNF refers to fine cellulose fibers obtained by fibrillating pulp fibers. In general, CNF refers to cellulose fibers containing cellulose fine fibers having a fiber width of nano-order size (1 nm or more and 1000 nm or less). An average fiber width is preferably 100 nm or less. Number average, median, mode diameter (mode) and the like are calculated from a certain number of fibers as the average fiber width.

Examples of pulp fibers usable for the production of CNF include chemical pulp such as broad leaf tree pulp (LBKP) and needle leaf tree pulp (NBKP); mechanical pulp such as Bleaching thermomechanical pulp (BTMP), stone ground pulp (SGP), pressurized stone ground pulp (PGW), refiner ground pulp (RGP), chemi-ground pulp (CGP), thermogrand pulp (TGP), grand pulp (GP), thermomechanical pulp (TMP), chemi-Thermo Mechanical pulp (CTMP), and refiner mechanical pulp (RMP); used paper pulp manufactured from tea waste paper, craft envelope waste paper, magazine waste paper, newspaper waste paper, leaflets waste paper, office waste paper, cardboard waste paper, high quality white waste paper, Kent waste paper, simili waste paper, regional waste paper, and groundwood paper; and deinked pulp (DIP) made by deinking used paper pulp. As long as the effects of the present invention are not impaired, these may be used alone or in combination of multiple kinds.

Methods for producing CNF are not limited to, but include mechanical methods such as a high pressure homogenizer method, a microfluidizer method, a grinder grinding method, a bead mill freeze pulverization method, and an ultrasonic fibrillating method.

For example, chemical treatment such as carboxymethylation may be applied to pulp fibers to which fibrillating treatment of a mechanical method was applied. Enzyme treatment may also be applied.

The fibrillating treatment of a mechanical method may be applied to CNF to which chemical treatment and/or enzyme treatment was applied.

The toilet cleaning sheet 100 may be in a state of being uniformly impregnated with CMC in the thickness direction of the base paper sheet, but preferably in a state in which the content of CMC in the base paper sheet gradually increases from the center in the thickness direction toward the front face and the back face. As a result, the toilet cleaning sheet 100 is less likely to be torn even if it is used for rubbing the rim of a toilet bowl strongly, as compared with a conventional product which is uniformly impregnated with the water-soluble binder of the same amount.

The fiber orientation ratio (length/width) in the length and width directions of the toilet cleaning sheet 100 is not particularly limited, but it is preferably 0.8 to 2.0, more preferably 0.8 to 1.2.

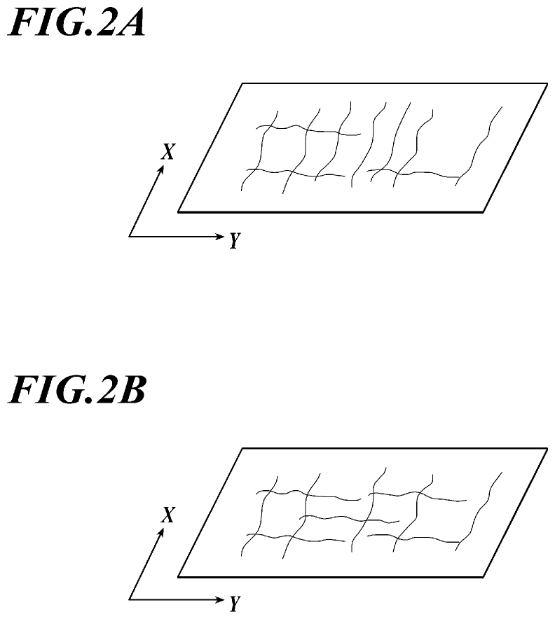

In the papermaking step which is a step for producing paper, since fibers are spread over wire(s) of a papermaking machine and flows in the transport direction, many fibers are generally aligned in the length direction which is the conveyance direction of the papermaking machine (for example, length:width=2.3:1, refer to FIG. 2A) on the paper. Therefore, the fiber density in the width direction is low so that the fiber tends to break. That is, it tends to be torn depending on the wiping direction. Therefore, in the present embodiment, as shown in FIG. 2B, the fiber orientation ratio in the length and width directions of the toilet cleaning sheet 100 is set to 0.8 to 2.0, preferably 0.8 to 1.2. As a result, it is possible to provide the toilet cleaning sheet 100 which is hard to be torn even by wiping with it in any direction. The fiber orientation ratio in the length and width directions can be obtained from the ratio of the wet strengths in the MD to CD directions.

[Aqueous Agent]

The toilet cleaning sheet 100 of the present embodiment is impregnated with a predetermined aqueous agent containing the cross-linking agent for cross-linking with the water-soluble binder (CMC in the case of toilet cleaning sheet 100 in the present embodiment). The aqueous agent contains, in addition to the cross-linking agent, propylene glycol monomethyl ether, butyldiglycol and propylene glycol that are glycol ethers, an aqueous detergent, an antiseptic, a disinfectant, an organic solvent and the like as the auxiliary agent.

The dried base paper sheet is impregnated with the aqueous agent after impregnation of water-soluble binder.

The aqueous agent used for the impregnating is 100 to 500% by weight, preferably 150 to 300% by weight, relative to the weight of the base paper sheet as the base material of the toilet cleaning sheet 100.

As the cross-linking agent, boric acid, various metal ions and the like can be used, but when CMC is used as the water-soluble binder, a polyvalent metal ion is preferably used. In particular, it is preferable to use one or more of polyvalent metal ions selected from the group consisting of alkaline earth metals, manganese, zinc, cobalt, and nickel, from the viewpoint of developing wet strength for durability in use by sufficiently bonding the fibers and from the viewpoint of improving sufficient water-disintegrability. Among these metal ions, ions of calcium, strontium, barium, zinc, cobalt, or nickel are used particularly preferably.

The aqueous agent in the present invention contains propylene glycol monomethyl ether (hereinafter, referred to as PGME), butyldiglycol (hereinafter, referred to as BDG), and propylene glycol (hereinafter, referred to as PG).

PGME is known as being added as a cleansing component to improve the cleansing ability generally. PGME shows the effect of improving the sheet strength directly, and has the effect of enhancing the sheet strength improving effect by CMC and polyvalent metal ion. The amount of PGME to be added is preferably 5 to 30 g/m², more preferably 10 to 20 g/m².

BDG is an auxiliary agent that has the effect of improving the sheet strength similarly to PGME, and is an additive that the present inventor found. The amount of BDG to be added is preferably 5 to 30 g/m², more preferably 10 to 20 g/m².

PG is an auxiliary agent that solubilizes the antiseptic and the disinfecting agent. The amount of PG to be added is 3 to 14 g/m², more preferably 4 to 8 g/m².

As the aqueous detergent, for example, lower or higher (aliphatic) alcohol can be used in addition to a surfactant.

As the antiseptic, for example, parabens such as methylparaben, ethylparaben, propylparaben, and the like may be used.

As the disinfecting agent, for example, benzalkonium chloride, chlorhexidine gluconate, povidone iodine, ethanol, benzyl cetyl oxide, triclosan, chloroxylenol, isopropylmethylphenol, and the like may be used. As the organic solvent, polyhydric alcohols such as glycol (divalent), glycerin (trivalent), sorbitol (tetravalent), and the like may be used.

Further, the auxiliary agent of the above-mentioned components of the aqueous agent may be selected appropriately, and a component which fulfills other functions may be contained in the aqueous agent as necessary.

In such a way, CNF is blended into the base paper sheet in the present invention.

Thus, the specific surface area of the base paper sheet is larger than that of the composition including only the pulp.

[Embosses]

To the toilet cleaning sheet 100, embossing is preferably applied. For example, as shown in FIG. 1, two kinds of embosses EM11 and EM12 are embossed.

Although the shape, number, area ratio, etc. of the embosses are arbitrary, in the case of the toilet cleaning sheet 100, the embosses EM11 are arranged to form a diamond lattice. As a result, uneven wiping can be reduced as compared with the case where the embosses EM11 are arranged to form a square lattice or a rectangular lattice. The embosses EM12 are arranged between the embosses EM11.

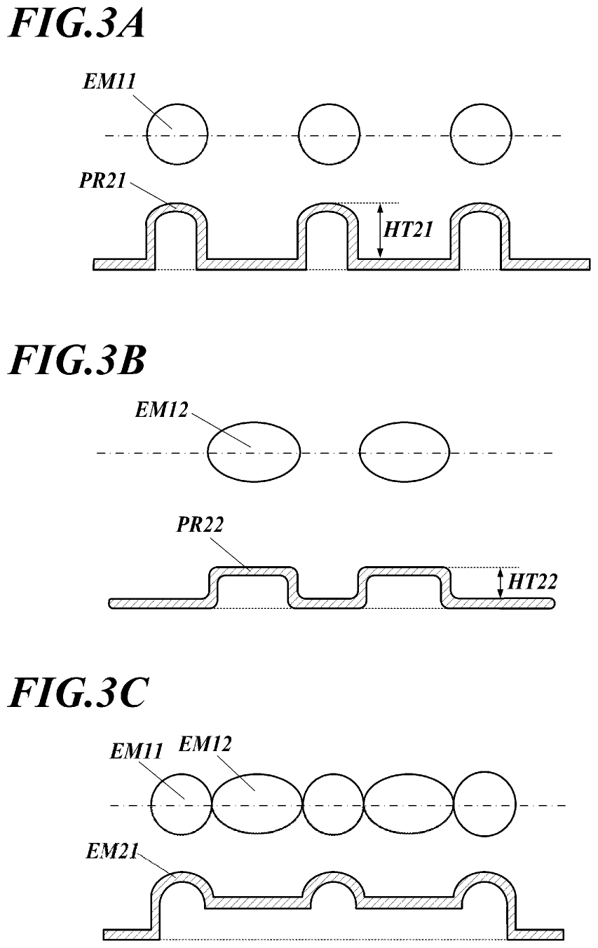

The embosses EM11 each have, as shown in FIG. 3A, a protrusion PR21 having a curved shape.

The embosses EM12 each have, as shown in FIG. 3B, a protrusion PR22 having a plane shape.

Since the embosses EM12 are arranged between the embosses EM11, the protrusions PR21 of the embosses EM11 and the protrusions PR22 of the embosses EM12 are closely adhered to each other to form a continuous emboss EM21 as shown in FIG. 3C.

Alternatively, the protrusions PR21 of the embosses EM11 and the protrusions PR22 of the embosses EM12 may be only close to each other and do not have to be continuous.

By forming the two kinds of embosses EM11 and EM12 in this way, it is possible to increase contact areas with the object to be cleaned. As a result, the toilet cleaning sheet 100 becomes less stiff and has higher wiping property.

That is, by forming the embosses EM11 whose protrusions PR21 have a curved surface and the embosses EM12 whose protrusions PR22 have a plane surface on the entire sheet surface of the toilet cleaning sheet 100, the respective embosses are deformed and the contact areas increase for the first time when a force is applied to the toilet cleaning sheet 100 during the wiping operation. Therefore, as well as increasing the contact areas, flexibility is also improved due to deformation of the respective embosses.

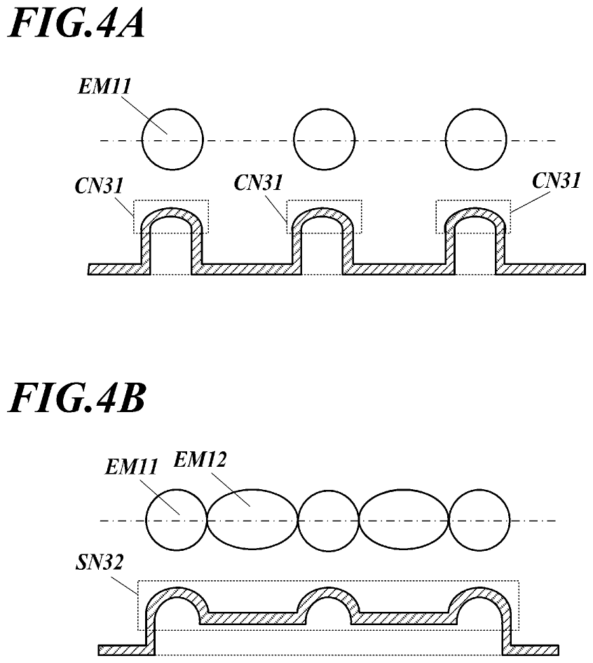

For example, as shown in FIG. 4A, if there is a single kind of embosses EM11, the contact areas CN31 after deformation of the embosses EM11 due to the force applied to the toilet cleaning sheet 100 during the wiping operation are generated discretely in the vicinity of the respective embosses EM11. On the other hand, if there are two kinds of embosses EM11 and EM12 in combination, as shown in FIG. 4B, the contact areas SN32 after deformation of the embosses EM11 and EM12 due to the force applied to the toilet cleaning sheet 100 during the wiping operation are increased as compared with the contact area CN31 of FIG. 4A.

Further, the two kinds of embosses EM11 and EM12 also exhibit the effect of normal embosses, and it is possible to improve the texture, absorbency, bulkiness, etc. of the toilet cleaning sheet. Furthermore, as well as ordinary embosses, the continuous embosses EM11 and EM21 also exhibit the effect of good appearance by embossing.

The toilet cleaning sheet 100 is folded in two at the center portion in the Y direction by a fold process. Then, it is stored in a plastic case for storage or in a packaging film in a folded state, and unfolded as necessary at the time of use. The way of folding the toilet cleaning sheet 100 is not limited to folding in two, but may be folding in four or eight, for example.

[Method for Producing Toilet Cleaning Sheet]

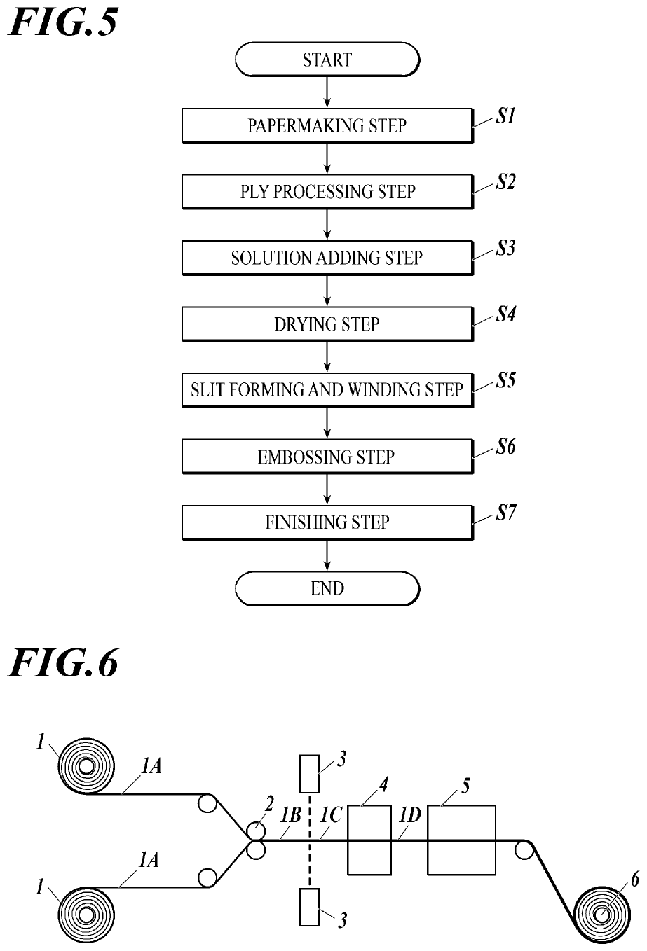

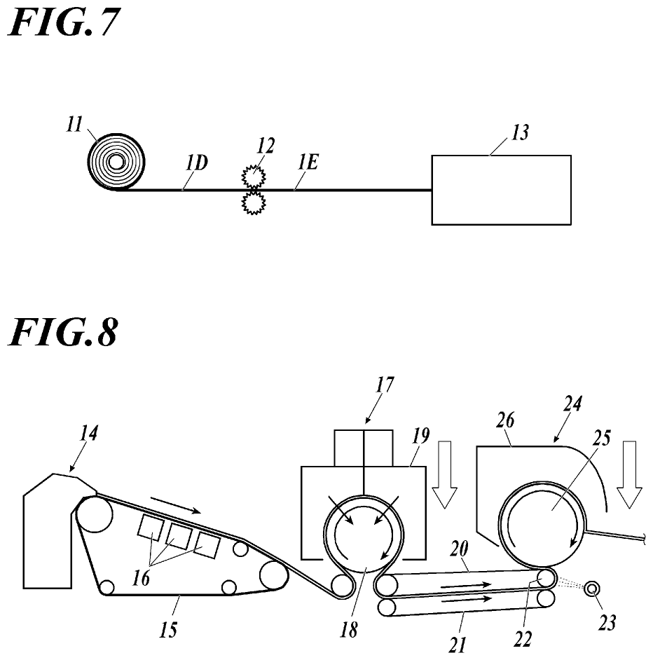

Next, a method for producing the toilet cleaning sheet will be described. FIG. 5 is a flowchart showing a method for producing the toilet cleaning sheet. FIG. 6 is a schematic diagram of solution adding equipment for adding a water-soluble binder solution to the base paper sheet (paper sheet) of the toilet cleaning sheet. FIG. 7 is a schematic view of processing equipment for processing the base paper sheet to which the water-soluble binder solution has been added in the solution adding equipment shown in FIG. 6.

In the method for producing the toilet cleaning sheet, as shown in FIG. 5, first, a papermaking step (S1) of making a paper to be a base paper is performed with a papermaking machine (not shown).

Next, as shown in FIGS. 5 and 6, in the solution addition equipment, the ply processing step (S2) of making a ply continuous sheet 1B by the ply process of the continuous dry base paper 1A, 1A which are respectively drawn out from multiple (for example, two) primary web rolls 1, 1 on which the base paper is wound up after papermaking; a solution adding step (S3) of adding the water-soluble binder solution to the ply continuous sheet 1B to form a continuous sheet 1C; a drying step (S4) of drying the continuous sheet 1C; and a slit forming and winding step (S5) of forming a slit and winding the dried continuous water-disintegrable sheet 1D are performed. Although the number of primary web rolls can be appropriately changed as long as it is two or more, in the following descriptions, an example of using two primary web rolls will be described.

Next, as shown in FIGS. 5 and 7, in the processing equipment, an embossing step (S6) of embossing the continuous water-disintegrable sheet 1D drawn out from the secondary web roll 11 after winding in the slit forming and winding step (S5), and a finishing step (S7) of applying finish process to the embossed sheet 1E on which embossing has been performed.

Details of each step will be described later.

[Papermaking Step]

First, the papermaking step (S1) according to the present embodiment will be described. In the papermaking step (S1) of the present invention, for example, the base paper sheet is formed by making a papermaking raw material into paper by a known wet papermaking technique. That is, after making the papermaking raw material in a state of wet paper, it is dried with a dryer or the like to form the base paper sheet such as thin paper or crepe paper.

Besides pulp and a coagulant, papermaking chemicals such as wet paper strength agent, adhesive, release agent and the like may be appropriately used in the base paper sheet.

In addition, although the water-soluble binder solution is added in a solution addition step in the solution addition equipment described later in the embodiment of the present invention, the water-soluble binder solution may be added in the papermaking step.

If the water-soluble binder solution is also added in the papermaking step, it is possible to increase the strength of the entire water-disintegrable sheet which is obtained. Then, by further adding the water-soluble binder solution in the solution adding step of the subsequent step, the surface strength of the water-disintegrable sheet can be further increased.

As a method of adding the water-soluble binder solution in a papermaking step, for example, a method of wet papermaking using a raw material in which the water-soluble binder and a fixing agent to fix the water-soluble binder to the pulp fibers are added to a dispersion containing pulp as a papermaking raw material (JP H03-193996 A). That is, the water-soluble binder is internally added in the method. It is also possible to perform wet papermaking of a sheet from a dispersion containing pulp, to spray and dry or to coat and dry the water-soluble binder after press dewatering or semi-drying, and to produce a fiber sheet containing a predetermined amount of the water-soluble binder. That is, the water-soluble binder is externally added in the method. In this case, it is possible to obtain a fiber sheet with a lower density and better water-disintegrability by using a pre-drying system such as a hot air passage dryer rather than press dewatering. Furthermore, instead of the wet papermaking method described above, it is also possible to produce a fiber sheet by fibrillating the dry pulp fibers without using water, forming a web, spraying the water-soluble binder, and then drying process. It is a so-called air laid production method.

FIG. 8 shows a schematic diagram of an example of a producing apparatus preferably used for producing a fiber sheet where the water-soluble binder is used as a binder. The producing apparatus (wet papermaking machine) shown in FIG. 8 is provided with a former 14, a wire part, a first dry part 17, a spray part, and a second dry part 24.

The former 14 adjusts the finished paper material supplied from a preparation device (not shown) to a predetermined concentration and then supplies it to the wire part. The preparation device (not shown) is provided with a device for separating and pulverizing raw materials such as pulp fibers and an adding device for adding additives such as a sizing agent, a pigment, a paper strengthening agent, a bleaching agent, a coagulant and the like to the separated and pulverized raw material, and is configured to prepare the paper material including a raw material at a predetermined concentration according to the features of water-disintegrable paper as a finished paper material. It is also possible to mix a binder in pulp slurry. In the wire part, wet paper is formed from the finished paper material supplied from the former in a paper making net. In the first dry part 17, the wet paper formed in the wire part is dried. In the spray part, the binder is sprayed onto the paper dried in the first dry part 17. In the second dry part 24, the paper in wet condition with the binder sprayed at the spray part is dried.

The finished paper material supplied from the former 14 is subjected to papermaking at the wire part, and wet paper is formed on the wire 15. Moisture in the wet paper is removed by suction by a suction box 16 installed at the wire part, so that the wet paper has a predetermined moisture percentage. The wet paper is then introduced into the first dry part 17 and dried. The first dry part 17 is configured with a through air dryer (hereinafter referred to as TAD). The TAD includes a rotating drum 18 whose circumferential surface is air permeable, and a hood 19 which covers the rotating drum 18 substantially airtightly. In the TAD, air heated to a predetermined temperature is supplied into the hood 19. The heated air flows from the outside to the inside of the rotating drum 18. The wet paper is conveyed while being held on the circumferential surface of the rotating drum 18 rotating in the arrow direction in FIG. 8. While being conveyed through the TAD, the heated air penetrates the wet paper in the thickness direction thereof, whereby the wet paper is dried and becomes paper.

At the spray part, an aqueous solution including a binder (water-soluble binder solution) is sprayed on the paper obtained at the first dry part 17. The spray part is at a position between the first and second dry parts 17, 24. Both dry parts 17, 24 are connected via a conveyor.

The conveyor is provided with an upper conveyor belt 20 and a lower conveyor belt 21 each rotating in the arrow direction. The conveyor 20 is configured to convey the paper dried by the TAD of the first dry part 17 to the second dry part 24 in a state of being sandwiched between these belts 20, 21. A vacuum roll 22 is arranged at a folding back end on the downstream side of the upper conveyor belt 20. The vacuum roll 22 attracts paper on the back surface of the upper conveyor belt 20, and conveys the upper conveyor belt 20 under the attracting state.

As shown in FIG. 8, the spray part is provided with a spray nozzle 23. The spray nozzle 23 is arranged below the second dry part 24, facing the vacuum roll 22. The spray nozzle 23 sprays a spray liquid including the binder toward the vacuum roll 22 and adds (externally adds) the spraying liquid to the paper.

After the binder is supplied at the spray part, the paper is conveyed to the second dry part 24. The second dry part 24 is configured with a Yankee dryer. The paper in a wet state by spraying the spraying liquid is conveyed while being held on the circumferential surface of the rotating drum 25 of the Yankee dryer installed in the hood 26. The paper becomes dry while it is held and conveyed by the rotating drum 25.

The binder is supplied at the spray part at a position between the first and second dry parts 17 and 24. For example, the binder may be sprayed from above the upper conveyor belt 20 (the position indicated by the arrow between the first and second dry parts 17 and 24 shown in FIG. 8). Further, the binder may be sprayed from the upper side of the paper dried at the second dry part 24 (the position indicated by the arrow on the right side of the second dry part 24 shown in FIG. 8). Between the first and second dry parts 17, 24 and after the second dry part 24, the binder may be sprayed not only from the upper side but also from the lower side or from both the upper and lower sides.

In the present embodiment, in the papermaking step, the fiber orientation ratio in the length and width directions (length/width) of the base paper sheet is adjusted to 0.8 to 2.0, preferably 0.8 to 1.2. The fiber orientation can be adjusted in the papermaking machine, for example, by adjusting the angle at which the papermaking raw material is supplied to the wire part. The angle at which the papermaking raw material is supplied may be adjusted, for example, by adjusting the slice opening degree of the head box. Alternatively, the fiber orientation may be adjusted by giving vibration in a direction orthogonal to the conveyance direction (running direction) of the papermaking machine.

[Ply Processing Step]

Next, the ply processing step (S2) of the present embodiment will be described. In the ply processing step (S2), as shown in FIG. 6, the continuous dry base paper 1A, 1A each continuously drawn out from the web roll 1 is supplied to an overlapping unit 2 for the ply process along the continuous direction to form a ply continuous sheet 1B. The overlapping unit 2 is configured with a pair of rolls, performs the ply process of each continuous dry base paper 1A, 1A to form a ply continuous sheet 1B to which the ply process has been applied. When overlapping the continuous dry base paper 1A, 1A, it may be weakly fastened with pin embosses (contact embosses) so that the continuous dry base paper 1A, 1A is not easily displaced.

[Solution Adding Step]

Next, the solution adding step (S3) of the present embodiment will be described. In the solution adding step (S3), as shown in FIG. 6, the water-soluble binder solution is sprayed on both outer surfaces (the surface of the continuous dry base paper 1A, 1A which does not face the continuous dry base paper 1A, 1A after the ply process) of the ply continuous sheet (paper sheet) 1B by each of the two-fluid type spray nozzles 3, 3 to produce a continuous sheet 1C.

The water-soluble binder solution contains carboxyl methyl cellulose (CMC) as the water soluble binder. Further, the water-soluble binder solution may contain CNF.

As a method of spraying the water-soluble binder solution, the water-soluble binder solution described above may be sprayed onto one of the outer surfaces of the ply continuous sheet 1B. A sheet equivalent to the continuous sheet 1C described above may be generated by spraying the above water-soluble binder solution from a two-fluid type spray nozzle on the outer surface (the surface of the sheet which does not face another sheet) of at least one of the continuous dry base paper 1A, 1A respectively drawn out from the above-described primary web rolls 1, 1, and immediately after that, by applying the ply process to the continuous dry base paper 1A, 1A.

The two-fluid type spray nozzle 3 is a spray nozzle for mixing and spraying compressed air and liquid divided into two systems. As compared with the one-fluid type spray nozzle from which sprays the compressed liquid alone, it is possible to spray the liquid finely and uniformly.

Though the spraying conditions can be set as needed, for example, the nozzle diameter of the spray nozzle 3 is set to 0.09 gal/min or less, with the concentration of the water-soluble binder solution; 3.0 to 4.0%, the discharge temperature; 50 to 70° C., the liquid pressure; 2 MPa or more, and the air pressure; 0.05 to 0.2 MPs.

By spraying the water-soluble binder solution onto the outer surface of the ply continuous sheet 1B in this way, the content of the CMC in the toilet cleaning sheet gradually increases from the inner side toward the outer side in the thickness direction. Therefore, it is possible to improve the surface strength while securing water-disintegrability, and to produce a toilet cleaning sheet with less damages even against strong rubbing.

As for the inner side and the outer side in the thickness direction, in the case of application to both surfaces, the center in the thickness direction is referred to as the inner side and the outer surface is referred to as the outer side. In the case of application to one surface, a surface to which the water-soluble binder solution is not applied is referred to as the inner side, and the surface to which the water-soluble binder solution is applied is referred to as the outer side.

[Drying Step]

Next, the drying step (S4) of the present embodiment will be described. In the drying step (S4), as shown in FIG. 6, the insoluble liquid in the water-soluble binder solution of the continuous sheet 1C evaporates in the drying equipment 4, so that the effective ingredient, in particular CMC, is fixed to the fibers.

Here, since the impregnating amount of the water-soluble binder solution decreases from the outer side of the continuous sheet 1C toward the inner side in the thickness direction, the CMC fixing amount decreases toward the inner side in the thickness direction. Therefore, in impregnation with the aqueous agent in the finishing step (S7) described later, the cross-linking reaction becomes difficult to occur and the gaps increases toward the inner side in the thickness direction. As a result, the aqueous agent can be confined in the sheet. Therefore, the obtained toilet cleaning sheet is difficult to dry.

As the drying equipment 4, dryer equipment with a hood for blowing hot air against the continuous sheet 1C and drying it can be used. In order to adhere the sheets more tightly to each other, a press roll or a turn roll may be installed and the continuous sheet 1C may be passed through the press roll or the turn roll before the drying step (S4).

The drying equipment may be infra-red irradiation equipment. In this case, multiple infrared ray irradiation units are arranged in parallel in the conveyance direction of the continuous sheet 1C, and the continuous sheet 1C to be conveyed is irradiated with infrared rays and becomes dry. Since moisture is heated by the infrared rays and dried, it can be uniformly dried compared with a dryer with hot air, and the occurrence of wrinkles in the slit forming and winding step is prevented in the subsequent stage.

[Slit Forming and Winding Step]

Next, the slit forming and winding step (S5) of the present embodiment will be described. In the slit forming and winding step (S5), in order to prepare a web to be processed with an off-line processing machine from a continuous water-disintegrable sheet 1D to which the ply process has been applied, the continuous water-disintegrable sheet 1D dried in the drying step (S4) and to which CMC has been fixed is subjected to slit formation at a predetermined width with a slitter 5 while adjusting the tension, and is wound in winder equipment 6. The winding speed is determined as appropriate considering the ply processing step (S2), solution adding step (S3) and drying step (S4). It should be noted that the sheet breaks if the winding speed is too rapid, and wrinkles will occur if it is too slow.

By crimping the continuous water-disintegrable sheet 1D to which the ply process has been applied in the slit forming and winding step (S5), the continuous water-disintegrable sheet 1D is further integrated so as to be substantially one sheet.

[Embossing Step]

Next, the embossing step (S6) of the present embodiment will be described. In the embossing step (S6), as shown in FIG. 7, the continuous water-disintegrable sheet 1D drawn out from the secondary web roll 11 is subjected to embossing for forming a predetermined shape on the entire surface of the sheet by the embossing roll 12. The object of this embossing is to enhance the strength, bulkiness, wiping property, etc. of the sheet and to improve the design.

[Finishing Step]

Next, the finishing step (S7) of the present embodiment will be described. In the finishing step (S7), as shown in FIG. 7, the following steps are performed as a series of events in the finishing processing equipment 13: cutting of the embossed sheet 1E; folding of the respective cut sheets, impregnation with the aqueous agent (including a cross-linking agent, a paper strengthening agent (glycol ethers), an aqueous detergent, an antiseptic, a disinfectant, organic solvent, etc.) to the respective folded sheets, and packaging of the respective sheets impregnated with the aqueous agent.

Through these steps, the toilet cleaning sheet is produced.

### EXAMPLES

The aqueous agent used to impregnate the toilet cleaning sheet 100 in the present embodiment includes glycol ethers. As the glycol ethers, PGME, BDG and PG were adopted.

The evaluation results are described regarding the surface strength, water-disintegrability and odor of the toilet cleaning sheet impregnated with the aqueous agent for which the blending of PGME, BDG and PG was adjusted.

<Sample Preparation>

First, as a web, 2-ply sheet having a weight per unit area of 86 gsm in a dried state was prepared.

Next, in the water-soluble binder application equipment, the binder solution of water 96% and CMC 4% was sprayed onto the outer surface of the above sheet.

Next, it was dried until the moisture percentage reached about 8% by passing through a hot air dryer (temperature 180° C.), and while forming slits at a predetermined width, a web for processing the base paper sheet was prepared.

CMC contained in the binder solution is CMC 1330 (Daicel Corporation).

It was impregnated with an aqueous agent that contains glycol ethers by 10%, 14.5%, 19% and 7% (Example 19) respectively and that was adjusted to have the blending of PGME, BDG and PG shown in the following Table I, Table II, Table III and Table IV, to prepare samples of Examples 1 to 20 and Comparative Examples 1 to 3.

The aqueous agent used for impregnating was 166% by weight with respect to the weight of the web.

The impregnating rate of the aqueous agent (chemical solution) is the rate obtained by measuring the mass of base paper sheet before impregnated with the chemical solution and the mass of the chemical solution used to impregnate the base paper sheet, and calculating the rate of the mass of chemical solution with respect to the mass of the base paper sheet before impregnated with the chemical solution.

<Test Method regarding Surface Strength>

The test pieces (toilet cleaning sheets) were each cut off to width 75 mm×length 240 mm in MD direction and CD direction without peeling off the ply, folded into three with both end regions in the width direction overlapped, and rubbed with a Gakushin type fastness rubbing tester at the portion to be measured. The number of rubbings was measured at the time when damage such as scuffing or tear was visually confirmed on the paper. This measurement was performed four times in each of the MD direction and CD direction, and the average of the four measured values for each direction was calculated. The MD direction indicates a direction corresponding to the paper traveling direction on the papermaking machine, and the CD direction indicates a direction corresponding to the direction orthogonal to the paper traveling direction on the papermaking machine.

The test conditions by the Gakushin type fastness rubbing tester were as follows.

Gakushin Type Fastness Rubbing Tester: manufactured by TESTER SANGYO CO., LTD., Item Number AB301

Rubbing Finger:

| | |
|---|---|
| Shape | □ 20 mm × R 50 mm |
| Load | 200 gf (With white cotton cloth fixed, including |
| | arm) |
| Load Per Unit Area | 50 gf/cm2 (Load 200 gf/contact area 4.0 cm²) |

As the fixing cotton cloth for the rubbing finger, one piece of PP band (Sekisui Jushi Corporation, Item Number 19K (width 15 mm×length 60 mm)) was fixed to the rubbing finger with screws so that there are no gaps or wrinkles.

Sample Holder:

| | |
|---|---|
| Shape | R200 mm |
| Stroke | 120 mm |
| Reciprocating Frequency | 30 cps |

Test Piece (Toilet Cleaning Sheet): Width 25 mm (test piece with a width of 75 mm was folded in three without peeling off the ply)×length 240 mm (Sample holder side)

Test Procedure:

(1) Mount the test piece on the sample holder so that it is not loose.
(2) Gently lower the rubbing finger to the sample holder.
(3) Press the start SW to start the test.

Judgment Method: By confirming the state of the test piece after Gakushin processing (rubbing), the number of rubbing was measured at the time when damage such as tear was visually confirmed on the paper.

These test results are shown in Tables I to IV.

<Water-Disintegrability Test>

The water-disintegrability (easiness of loosening) test of the sample was performed based on JIS P 4501:2006. The result was measured by seconds, and the average of six measured values was calculated.

These teste results are shown in Tables I to IV.

<Odor Sensory Test>

With a sample of PGME 35%, BDG 35% and PG 30% (in the case of Table I; Example 4, in the case of Table II; Example 10, in the case of Table III; Example 16) as a reference, sensory evaluation comparing the odor of each sample was performed by 30 persons. The evaluation was performed by a scoring method (odor is strong; 5 points, slightly strong; 4 points, ordinary/not strong or weak; 3 points, slightly weak; 2 points, and weak; 1 point) that applies points to evaluations evaluating the odor as strong to weak, and the average of scores by the respective persons was calculated. When the average point is less than 2.5, the odor was determined as reduced compared to the Comparative Example 1 in the case of Table 1, compared to the Comparative Example 2 in the case of Table II, and compared to the Comparative Example 3 in the case of Table III.

The breakdown of 30 persons is 8 persons in 20s, 11 persons in 30s, 8 persons in 40s, and 3 persons in 50s. Since singular values are removed from the data, the score data for 27 persons was actually adopted.

These test results are shown in Tables I to III.

TABLE 1
Table I
Case of Glycol Ethers 10%

| | | | | | | | | Compar- |
|---|---|---|---|---|---|---|---|---|
| | | | | | | | | ative |
| | | Example | Example | Example | Example | Example | Example | Example |
| | | 1 | 2 | 3 | 4 | 5 | 6 | 1 |
| Glycol Ethers | PGME Amount [%] | 0 | 14 | 21 | 35 | 42 | 56 | 70 |
| in | BDG Amount [%] | 70 | 56 | 49 | 35 | 28 | 14 | 0 |
| Chemical Solution | PG Amount [%] | 30 | 30 | 30 | 30 | 30 | 30 | 30 |
| Impregnating Rate [%] | | 166 | | | | | | |
| Web | | 86 gsm (2-ply) | | | | | | |
| Dimension [mm] | | 330 × 230 | | | | | | |
| Surface Strength | MD | 62 | 73 | 75 | 76 | 63 | 59 | 53 |
| [number of rubbings] | CD | 46 | 56 | 51 | 52 | 49 | 46 | 44 |

| | | | | | | | |
|---|---|---|---|---|---|---|---|
| Water-Disintegrability [second] | 80 | 72 | 72 | 64 | 75 | 69 | 73 |
| Sensory Evaluation (Average Point) | 1.90 | 1.93 | 2.10 | 2.47 | 2.86 | 2.90 | 3.63 |

TABLE 2
Table II
Case of Glycol Ethers 14.5%

| | | | | | | | | Compar- |
|---|---|---|---|---|---|---|---|---|
| | | | | | | | | ative |
| | | Example | Example | Example | Example | Example | Example | Example |
| | | 7 | 8 | 9 | 10 | 11 | 12 | 2 |
| Glycol Ethers | PGME Amount [%] | 0 | 14 | 21 | 35 | 42 | 56 | 70 |
| in | BDG Amount [%] | 70 | 56 | 49 | 35 | 28 | 14 | 0 |
| Chemical Solution | PG Amount [%] | 30 | 30 | 30 | 30 | 30 | 30 | 30 |
| Impregnating Rate [%] | | 166 | | | | | | |
| Web | | 86 gsm (2-ply) | | | | | | |
| Dimension [mm] | | 330 × 230 | | | | | | |
| Surface Strength | MD | 88 | 92 | 99 | 98 | 89 | 87 | 66 |
| [number of rubbings] | CD | 63 | 69 | 65 | 67 | 64 | 50 | 42 |

| | | | | | | | |
|---|---|---|---|---|---|---|---|
| Water-Disintegrability [second] | 92 | 92 | 92 | 94 | 84 | 81 | 77 |
| Sensory Evaluation (Average Point) | 1.17 | 1.87 | 2.23 | 2.43 | 2.77 | 3.37 | 3.63 |

TABLE 3
Table III
Case of Glycol Ethers 19%

| | | | | | | | | Compar- |
|---|---|---|---|---|---|---|---|---|
| | | | | | | | | ative |
| | | Example | Example | Example | Example | Example | Example | Example |
| | | 13 | 14 | 15 | 16 | 17 | 18 | 3 |
| Glycol Ethers | PGME Amount [%] | 0 | 14 | 21 | 35 | 42 | 56 | 70 |
| in | BDG Amount [%] | 70 | 56 | 49 | 35 | 28 | 14 | 0 |
| Chemical Solution | PG Amount [%] | 30 | 30 | 30 | 30 | 30 | 30 | 30 |
| Impregnating Rate [%] | | 166 | | | | | | |
| Web | | 86 gsm (2-ply) | | | | | | |
| Dimension [mm] | | 330 × 230 | | | | | | |
| Surface Strength | MD | >300 | >300 | >300 | >300 | >300 | >300 | >300 |
| [number of rubbings] | CD | >300 | >300 | >300 | >300 | >300 | >300 | >300 |

| | | | | | | | |
|---|---|---|---|---|---|---|---|
| Water-Disintegrability [second] | 94 | 98 | 101 | 98 | 93 | 102 | 87 |
| Sensory Evaluation (Average Point) | 1.17 | 1.70 | 2.33 | 2.40 | 3.03 | 3.37 | 3.60 |

TABLE IV

| | | Example | Example | Example |
|---|---|---|---|---|
| | | 3 | 19 | 20 |
| Glycol Ethers | | 10% | 7% | 10% |
| Glycol Ethers | PGME Amount | 21 | 30 | 30 |
| in | [%] | | | |
| Chemical Solution | BDG Amount | 49 | 70 | 70 |
| | [%] | | | |
| | PG Amount [%] | 30 | 0 | 0 |
| Impregnating Rate [%] | | 166 | | |
| Web | | 86 gsm (2-ply) | | |
| Dimension [mm] | | 330 × 230 | | |
| Surface Strength | MD | 75 | 77 | 89 |
| [number of rubbings] | CD | 51 | 52 | 79 |

| | | | |
|---|---|---|---|
| Water-Disintegrability [second] | 72 | 70 | 82 |

As shown in Tables I to III, when the sample (Examples 1 to 4, Examples 7 to 10 and Examples 13 to 16) was impregnated with an aqueous agent that contains glycol ethers by 10%, 14.5% and 19% respectively and contains BDG by 35% or more in the glycol ethers, the odor of the toilet cleaning sheet was at a level that is not felt uncomfortable in use, and the toilet cleaning sheet was a toilet cleaning sheet that can be suitably used without caring its odor.

As for the water-disintegrability, every sample was at a level having no problem in use.

As for the surface strength, as shown in Table I, it was found that each sample (Examples 2 to 4) impregnated with an aqueous agent that contains glycol ethers by 10% and contains BDG by 35 to 56% in the glycol ethers has a strength higher than the strengths of other samples. To be specific, the number of times of rubbing in the MD direction exceeds 70 times and the number of times of rubbing in the CD direction exceeds 50 times, which shows that the sample has a higher strength than the strengths of the other samples.

In addition, as shown in Table II, it was found that each sample (Examples 8 to 10) impregnated with an aqueous agent that contains glycol ethers by 14.5% and contains BDG by 35 to 56% in the glycol ethers has a strength higher than the strengths of other samples. To be specific, the number of times of rubbing in the MD direction exceeds 90 times and the number of times of rubbing in the CD direction exceeds 65 times, which shows that the sample has a higher strength than the strengths of the other samples.

In addition, as shown in Table III, in the samples impregnated with the aqueous agent containing the glycol ethers by 19%, the damages that the respective samples were torn did not occur. The damage such as loose fibers generated on the surface of each sample (Examples 14 to 16) impregnated with an aqueous agent that contains glycol ethers by 19% and contains BDG by 35 to 56% in the glycol ethers is less than the damage of other samples, which showed that the strength of the sample (Examples 14 to 16) is higher than the strengths of the other samples.

In this way, the present inventor found that the aqueous agent that was adjusted to have a proper blending of PGME, BDG and PG as the glycol ethers can improve the strength of toilet cleaning sheet.

In addition, as shown in Table IV, it was found that the water-disintegrability and the surface strength are little influenced even when PG in the glycol ethers is not used.

This shows that adjusting the use amount and/or blending rate of BDG as a glycol ether contained in the aqueous agent enables suitable use without caring the odor and provides a toilet cleaning sheet having a good surface strength.

As described above, the toilet cleaning sheet 100 in the present embodiment is a cleaning sheet obtained by impregnating the base paper sheet with an aqueous agent that contains butyldiglycol as a glycol ether (Examples 1 to 6, Examples 7 to 12, Examples 13 to 18, and Examples 19 to 20).

By replacing at least part of propylene glycol monomethyl ether contained in the aqueous agent with butyldiglycol, it is possible to suppress the odor for the replacing amount.

A more preferable toilet cleaning sheet 100 contains glycol ethers by 10 to 19% in the aqueous agent and contains butyldiglycol by 35 to 56% in the glycol ethers (Examples 2 to 4, Examples 8 to 10, and Examples 14 to 16).

The toilet cleaning sheet 100 impregnated with the aqueous agent of this blending can be suitably used as a cleaning sheet having a strength that can withstand a cleaning operation.

Furthermore, a toilet cleaning sheet 100 that contains butyldiglycol by 50% or more in the glycol ethers contained in the aqueous agent (Examples 1 to 2, Examples 7 to 8 and Examples 13 to 14) can be suitably used as an unscented type toilet cleaning sheet 100 with no fragrance.

In this way, the toilet cleaning sheet 100 of the present embodiment can be suitably used for the use of cleaning.

Application of the present invention is not limited to the above-mentioned embodiment, and modifications can be appropriately made within the scope of the present invention.

### INDUSTRIAL APPLICABILITY

Due to the configuration as mentioned above, the present invention can be used as a cleaning sheet that can suppress an odor while having a surface strength and can be suitably used, and a method for producing the cleaning sheet.

### REFERENCE SIGNS LIST

100 toilet cleaning sheet
EM11, EM12 emboss

1-6. (canceled)

7. A cleaning sheet comprising a base paper sheet that is impregnated with an aqueous agent, wherein the aqueous agent includes butyldiglycol that is a glycol ether.

8. The cleaning sheet according to claim 7, wherein the aqueous agent includes a glycol ether by 10 to 19%, and includes butyldiglycol by 35 to 56% in the glycol ether.

9. The cleaning sheet according to claim 7, wherein a glycol ether included in the aqueous agent includes butyldiglycol by 50% or more.

10. The cleaning sheet according to claim 7, wherein
the base paper sheet contains a water-soluble binder, and
the aqueous agent includes a cross-linking agent that cross-links with the water-soluble binder.

11. A method for producing a cleaning sheet comprising:
CNF adding that is adding cellulose nanofibers to a base paper sheet; and
aqueous agent adding that is adding, to the base paper sheet, an aqueous agent that includes propylene glycol monomethyl ether and butyldiglycol.

12. The method for producing the cleaning sheet according to claim 11, further comprising:
binder adding that is adding, to the base paper sheet, a solution that contains a water-soluble binder; and
drying that is drying a sheet to which the water-soluble binder and the cellulose nanofibers have been added, wherein
in the aqueous agent adding, the aqueous agent is added to the sheet that has been dried in the drying.
